(19) United States
(12) Patent Application Publication
(10) Pub. No.: US 2011/0148604 A1
(43) Pub. Date: Jun. 23, 2011

(54) Device and Method for Converting a Computing Device into a Remote Control

(75) Inventor: Andrew Kevin Miller, New Territories (CN)

(73) Assignee: Spin Master Ltd.

(21) Appl. No.: 12/640,457

(22) Filed: Dec. 17, 2009

(51) Int. Cl. G05B 11/01

(52) U.S. Cl. 340/12.22; 340/4.3

(57) ABSTRACT

There is provided a method and device allowing a user to remotely control an electronic device with infrared signals using a media player device. Sound signals, either generated by or saved on the media player device correspond to infrared commands and are invoked by the user through a user interface. The sound signal is played back by the media player device and is received by an external device, connected to the media player device through a port, such as the headphone jack. The external device then converts the sound signal into an infrared signal.

### FIELD OF THE INVENTION

The present invention relates to the remote control of electronic devices using infrared (‘IR’) waves. In particular, the present invention relates to a device and method for remotely controlling an electronic device by converting sound signals produced by a media player into an IR signal.

### BACKGROUND

Remote controlled devices are part of our everyday landscape. The low cost and simplicity of an IR remote control device makes it an ideal solution for consumer items of all types such as televisions, DVD players, air conditioning units, stereos, remotely controlled toys such as planes, cars, helicopters and the like.

Personal media players such as the iPod™ are also common place, and while many of them have the ability to communicate wirelessly, through technologies such as Wi-Fi™ and Bluetooth™, there is no commonly available way to allow personal media players to control existing consumer items which do not also contain such costly wireless solutions.

Therefore, it would be advantageous to allow handheld devices having media playback capability to remotely control IR enabled devices.

### SUMMARY OF THE INVENTION

There is therefore provided a device and method which enable a programmable device to send lift signals for the purpose of remotely controlling an electronic device. Specifically, there is provided a method and device, in which the device can be connected to an output port of a media player device, wherein the media player device outputs signals through the output port, and wherein the device translates the signal into an IR signal which is broadcast and subsequently received by an electronic device.

Therefore, according to one aspect of the present invention, there is provided a device for converting a computing system into a remote control for electronic devices, comprising an input port for receiving an audio signal from the computing system; an amplifier and filter circuit connected to the input port; a modulator circuit, the modulator circuit producing a carrier frequency; and an infrared emitter; wherein the infrared emitter is configured to transmit an infrared signal modulated on the carrier frequency and corresponding to the signal produced by the amplifier and filter circuit.

According to another aspect of the present invention, there is provided a computing device comprising a microprocessor; memory; an audio output port; and an application stored in the memory, the application being configured to send a signal to the audio output port in response to user input; wherein the signal corresponds to a command to be sent to a remotely controlled electronic device.

According to yet another aspect of the present invention, there is provided a method for remotely controlling an electronic device with a computing device, comprising the steps of: generating, at the computing device, a signal, the signal corresponding to a command to be sent to the electronic device; sending the signal to an audio output port of the media player device; receiving, at the input port of an infrared emitter, the signal from the audio output port of the media player device; converting, at the infrared emitter, the signal into an infrared signal; and emitting the infrared signal.

### BRIEF DESCRIPTION OF THE DRAWINGS

FIG. 1 is a symbolic representation of an infrared signal corresponding to a command.

FIG. 2 is a symbolic representation of a system according to one embodiment of the present invention.

FIG. 3 is a top plan view of a media player device displaying the user interface of an application according to one embodiment of the present invention.

FIG. 4 is a top plan view of a media player device displaying the user interface of an application according to one embodiment of the present invention.

FIG. 5 is a top plan view of a media player device displaying the user interface of an application according to one embodiment of the present invention.

FIG. 6 is a symbolic representation of an electronic circuit which may be used to implement an embodiment of the present invention.

FIG. 7 is a top plan view of an infrared emitter device according to an embodiment of the present invention.

FIG. 8 is a symbolic representation of a system according to one embodiment of the present invention.

### DETAILED DESCRIPTION

Each IR-operated electronic device is equipped with a receiver which is sensitive to infrared light and which can translate the actual infrared light into bits. In order to be differentiated from ambient light sources, the infrared signal is typically modulated on a carrier frequency which typically ranges from 30 to 45 KHz. In at least one embodiment, the carrier frequency is 38 kHz.

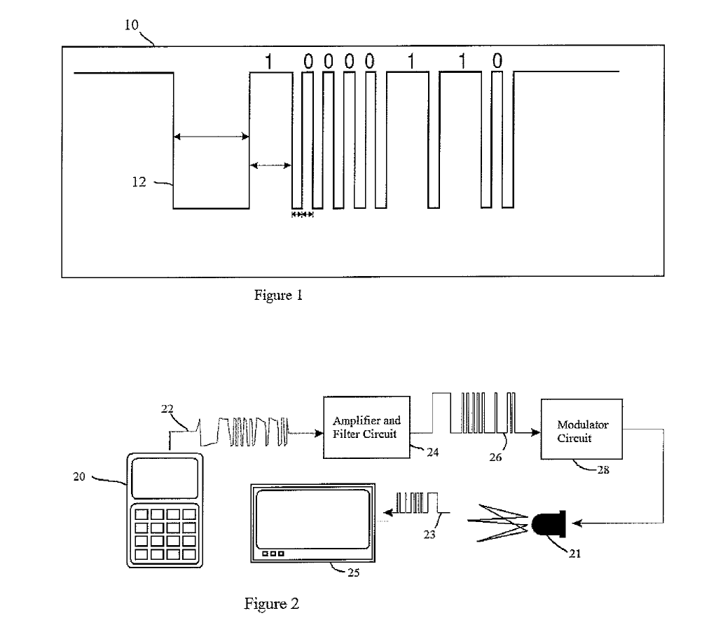

Reference is made to FIG. 1, which shows a typical 8-bit command signal to be sent to an IR-operated electronic device. The signal conveys 8 bits, which in this case are ‘10000110’. It is understood that the electronic device for which the signal is intended will interpret ‘10000110’ as some type of command, like for example, turning the electronic device on.

In particular, the signal 10 is started with a leader 12, of pre-determined duration, after which the signal's 8 bits are represented by crests of pre-determined durations. For example, in FIG. 1, a bit of ‘1’ is represented by a long crest followed by a trough. A ‘0’ bit is represented by a short crest followed by a trough. In the example of FIG. 1, all troughs are of equal duration. It will be understood by those skilled in the art that the signal of FIG. 1 is merely illustrative and other protocols for sending information through infrared are applicable to the present invention.

The present device and method allow a computing device, such as a media player, having the capability of playing prerecorded sound files or generating sound files dynamically, to produce an infrared signal such as the one depicted in FIG. 1. In particular, in at least one embodiment, the present method involves a media player playing or generating a sound signal which is received at an external device connected to the media player through the headphone jack. The signal is then amplified and filtered by a first circuit and then modulated on a high frequency by a second circuit. The signal is then sent to an infrared light source which broadcasts the infrared signal.

It will be appreciated by those skilled in the art that although the present disclosure refers to a “media player” or a “media player device”, the present invention can be used with any general purpose computing device, as long as the device is equipped with an audio output.

The above is better understood with reference to FIG. 2. In particular, FIG. 2 shows a media player device 20, which is characterized in that it has the capacity to playback pre-recorded sound files or generate sound files on the fly. The sound file is then converted to a signal 22, which is received by an amplifier and filter circuit 24, producing an amplified and filtered signal 26. The amplified and filtered signal 26 is then received by modulator circuit 28, which modulates the signal on a high carrier frequency, typically 30 to 45 KHz. The modulated signal is then sent to infrared light source 21, which broadcasts the infrared signal 23 to electronic device 25.

It should be appreciated that the above is provided for illustrative purposes only and is not meant to be limiting. For example, in an alternative embodiment shown in FIG. 8, signal 82, received from media player 80, is amplified and filtered by amplifier and filter circuit 84, to produce amplified and filtered signal 86. Infrared light source 81 receives a carrier frequency from the modulator circuit 88 and the amplified and filtered signal 86 separately.

As will be appreciated by those skilled in the art, while the electronic device 25 of FIG. 2 is depicted as a television set, the present invention may be used with any type of electronic device which is remotely controlled by infrared signals, including but not limited to remotely controlled toys. Those skilled in the art will further appreciate that the amplifier and filter circuit 24, the modulator circuit 28, and the infrared light source 21 are components of a device which, in operation, is connected to the media player 20 through a headphone jack or other output port, as will be discussed in greater detail below.

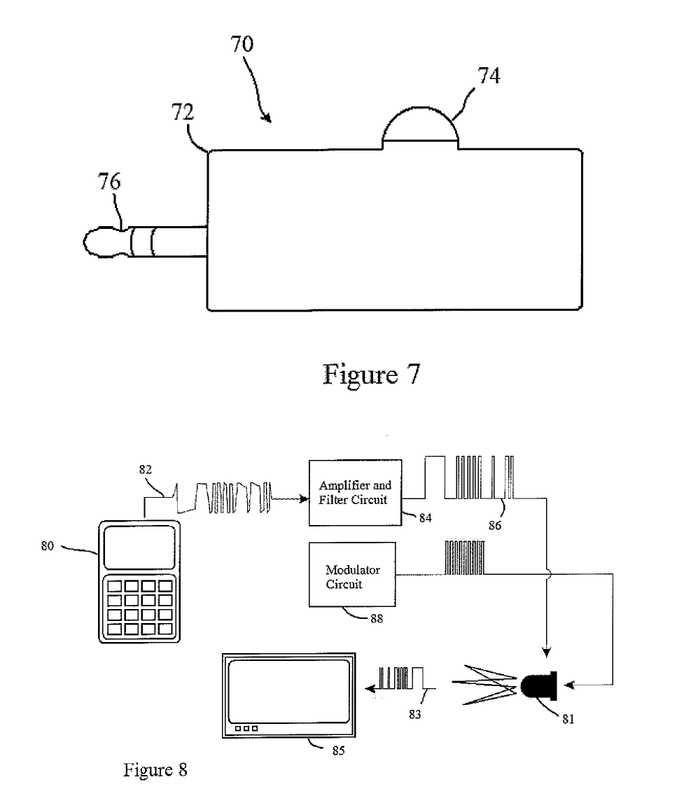

Reference is now made to FIG. 7, which shows an embodiment of the device that connects to a media player device. For simplicity, this device will be referred to as an infrared signal converter.

The infrared signal converter 70 includes a housing 72, an infrared source 74, and an input 76. As will be appreciated by people skilled in the art, within the housing 72 are circuits, such as the filtering, amplifying and modulating circuits discussed above. The input 76 is shown as a headphone jack, however any type of input suitable for receiving audio signals could be used.

In some embodiments, the media player maintains in memory a collection of sound files which correspond to commands for the electronic device. In other words, each sound file stored in memory would, when played by the media player and run through the amplifier and filter circuit 24, modulator circuit 28, and infrared source 21, produce an infrared signal such as the one depicted in FIG. 1.

In FIG. 1, the infrared signal conveys the byte ‘10000110’ which corresponds, for example, to the command ‘ON’. The sound signal which produces ‘10000110’ can be saved in a file and accessed when the user selects the ‘ON’ button from an application residing on the media player, as will be described in greater detail below. Other commands, such as ‘OFF’, ‘PLAY’, ‘STOP’, ‘REWIND’, would also correspond to a specific byte, which in turn would correspond to a sound file to be accessed based on user input.

For electronic devices like a television, there may be a known number of commands which can be sent. In such a case, every command may be saved in a sound file on the media player.

As will be appreciated by those skilled in the art, command sound files may be saved in a WAV format, or any other suitable audio format.

In some cases however, the number and types of commands to be sent may be too complex for the above solution to be practical. In such cases, it may be preferable to generate sound signals on the fly.

From the user's perspective, the electronic device may be controlled remotely using a media player by invoking an application residing on the media player. This application could come pre-loaded at the time of manufacture, or could be added to the device at a later time.

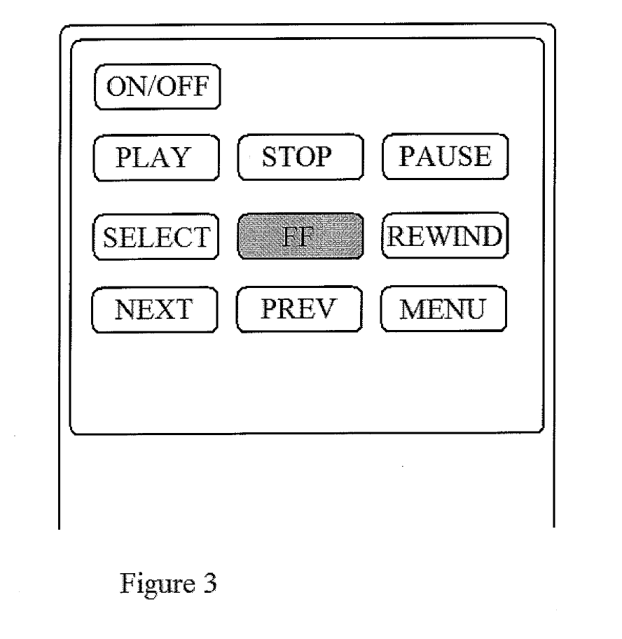

According to one embodiment, the application would include a graphical user interface (GUI) which mimics the appearance of an actual remote control device. An example of such a GUI is shown in FIG. 3.

As can be seen in FIG. 3, the GUI of the application includes all the buttons that would be expected on a conventional remote control device. The example of FIG. 3 mimics the remote control device of a DVD player, and therefore includes such functions as play, stop, pause, select, fast-forward, rewind, next, previous and menu. Other functions would be known to those skilled in the art.

As can also be seen in FIG. 3, the button for fast-forward (‘FF’) is currently selected by the application. The user can change the selected button by using a directional input or a touch screen of the media player device. The user may also activate a function by selecting it and pressing the appropriate button on the media player device.

In the embodiment of FIG. 3, when the user activates a function using the GUI, the application accesses the sound file associated with the activated function and plays it. The sound signal is then converted to an infrared signal by the device connected to the output port of the media player device as described above.

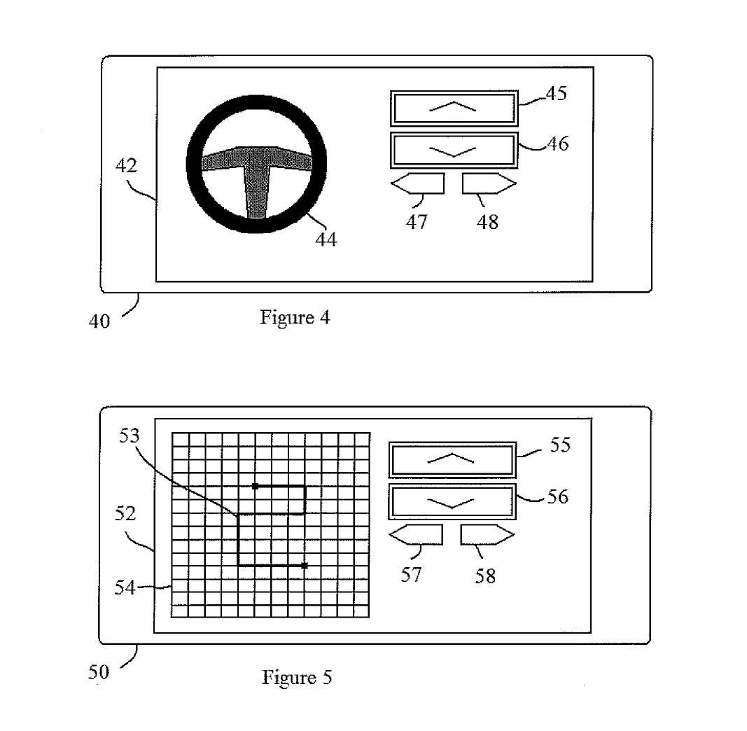

In some applications, a more complex application and GUI are required. For example, as seen in FIG. 4, there is shown a GUI for an application which controls a remotely controlled toy vehicle. In the example of FIG. 4, the media player device 40 includes a touch-screen 42. The GUI includes a steering wheel 44, forward and reverse buttons 45 and 46, as well as left and right buttons 47 and 48.

In the example of FIG. 4, the user may remotely control a toy vehicle by manipulating the GUI. The application would translate the input received from the user through the GUI into sound signals corresponding to infrared signals to be received by the toy vehicle.

As would be appreciated by people skilled in the art, the examples of FIG. 3 and FIG. 4 are merely illustrative and the present invention is not so limited. The present device and method may be modified to accommodate any device that is remotely controlled by infrared signals.

In another embodiment, the application on the media player device may provide an advanced GUI which provides the user with a level of abstraction above the traditional remote control. FIG. 5 shows an example of such a GUI.

FIG. 5 shows a media player device 50 with a touch screen 52 for controlling a toy vehicle, like that of FIG. 4. However, unlike the GUI of FIG. 4, the GUI of FIG. 5 shows a grid 54, having thereon a bolded line 53, representing a trajectory. The trajectory 53 is created by the user using the GUI, and represents the path that the user wants the toy vehicle to take once it is launched. When the user is satisfied with the trajectory, he may signal through the GUI to launch the vehicle. This will cause the application to translate the user-defined trajectory into sound signals which will be converted as discussed above into infrared commands, and which in turn will cause the toy vehicle to travel through the user-defined trajectory.

As will be appreciated by those skilled in the art, the example of FIG. 5 is merely illustrative, and the above concept can be adapted for other applications. Specifically, an application may provide the user with the ability to define compound commands which allows more complex operations to be defined and executed more easily.

Compound commands may be used in an embodiment of the present invention which controls a television set. As is known, modern television sets often provide complex menus to allow the user to optimize the television for a given application. For example, a user may wish to play games on a gaming console. This may require the user to press the INPUT button on the remote control four times, and the user may also wish to set his television's audio setting to GAMING. After, the same user may want to watch sports on television. This could require, for example, pressing the INPUT button twice, and switching the television's audio setting to SPORTS.

The present method and device allow the user to define compound commands to perform each of these operations with a single command, at least from the point of view of the user. Using the above example, the user could define a compound command for switching his television's settings from television to gaming, and from gaming to television. This could be done by using a portion of the application's GUI which is intended for this purpose, and compound commands could be saved in permanent storage and would appear on the application's main GUI, as other commands, or alternatively, in a sub-menu.

The exact definition of such compound commands, would, as is appreciated by those skilled in the art, depend on the particular television set for which they are intended. However, one may very well imagine a compound command for switching from television to gaming to look like this:

### INPUT;

### INPUT;

### INPUT;

### INPUT;

### MENU;

### DIRECTION-DOWN;

### DIRECTION-DOWN;

### DIRECTION-LEFT;

### EXIT;

The first four commands of the above compound command are INPUT, and serve to change the television's input setting from the television receiver to the gaming console's input. The MENU command brings up the television's interface for controlling various parameters. The two DIRECTION-DOWN commands bring the interface's cursor to the audio setting portion of the interface, and the DIRECTION-LEFT command changes the audio setting to GAMING. The EXIT command removes the interface from the television screen.

The above is merely an example, and any type of compound command, for any type of electronic device controlled by infrared commands could be created and used with the device and method of the present disclosure.

As will further be appreciated by those skilled in the art, it may be necessary, in some applications, to introduce a delay between commands of a compound command, in order to allow the electronic device for which the commands are intended to react to a first command before the next one is sent. A default delay could be automatically introduced, and could be in the order of 10 milliseconds. Additional delays could be introduced explicitly as part of the compound command's definition.

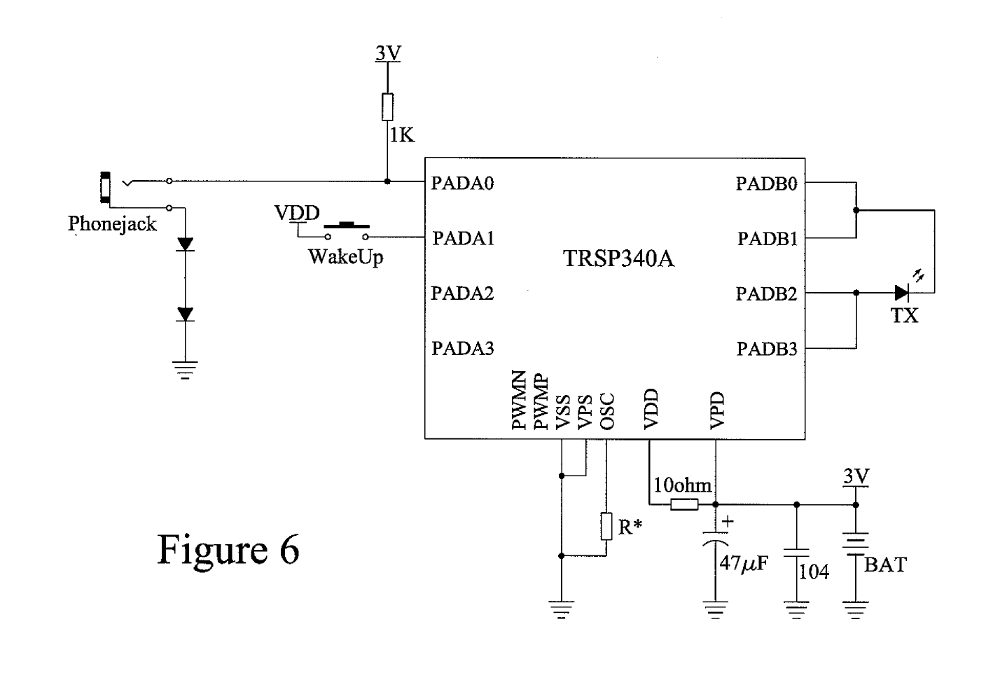

Reference is now made to FIG. 6. FIG. 6 shows an electronic circuit, and particularly a electronic circuit which uses a microcontroller unit and which performs the signal filtering, amplifying and modulating. However, it is important to note that those skilled in the art will be able to create circuits for performing these tasks in any number of ways. Thus, the circuit of FIG. 6 is provided for illustrative purposes only and is not limiting.

The embodiments of the present invention described herein are intended to be non-limiting. Various modifications which are readily apparent to the person of skill in the art are intended to be within the scope of the invention, the only limitations to which are set forth in the appended claims.

1. A device for converting a computing system into a remote control for electronic devices, comprising:
an input port for receiving an audio signal from the computing system;
an amplifier and filter circuit, connected to the input port;
a modulator circuit, the modulator circuit producing a carrier frequency; and
an infrared emitter;
wherein the infrared emitter is configured to transmit an infrared signal modulated on the carrier frequency and corresponding to the signal produced by the amplifier and filter circuit.

2. A computing device comprising:
a microprocessor;
memory;
an audio output port; and
an application stored in the memory, the application being configured to send a signal to the audio output port in response to user input;
wherein the signal corresponds to a command to be sent to a remotely controlled electronic device.

3. The computing device of claim 2, wherein the signal originates from a file stored in the memory.

4. The computing device of claim 2, wherein the signal is generated by the application.

5. The computing device of claim 2, wherein the application includes a user interface, the user interface allowing a user to select a command for the remotely controlled electronic device, and wherein selection of a command will cause the application to send a signal corresponding to the selected command.

6. The computing device of claim 5, wherein the user interface further allows the user to define compound commands, a compound command comprising a sequence of commands.

7. The computing device of claim 6, wherein compound commands are selectable by the user.

8. The computing device of claim 7, wherein when the user selects a compound command, the application sends a signal corresponding to each command of the selected compound command in sequence.

9. The computing device of claim 8, wherein the application delays for a predetermined period of time between the sending of each signal.

10. The computing device of claim 6, wherein compound commands further comprise user-defined delays.

11. The computing device of claim 2, wherein the remotely controlled electronic device is a toy vehicle and wherein the application includes a user interface, the user interface providing controls for the toy vehicle.

12. The computing device of claim 11, wherein the user interface allows a user to define a trajectory, and wherein the application is configured to send a plurality of signals to the output port, the plurality of signals corresponding to a plurality of infrared commands which cause the toy vehicle to move through the trajectory.

13. A method for remotely controlling an electronic device with a computing device, comprising the steps of:
generating, at the computing device, a signal, the signal corresponding to a command to be sent to the electronic device;
sending the signal to an audio output port of the computing device;
receiving, at the input port of an infrared emitter, the signal from the audio output port of the computing device;
converting, at the infrared emitter, the signal into an infrared signal; and
emitting the infrared signal.

14. A system for remotely controlling an electronic device comprising:
a device for converting a computing system into a remote control for electronic devices, and a computing system;
wherein the device comprises
an input port for receiving an audio signal from the computing system;
an amplifier and filter circuit, connected to the input port;
a modulator circuit, the modulator circuit producing a carrier frequency; and
an infrared emitter, wherein the infrared emitter is configured to transmit an infrared signal modulated on the carrier frequency and corresponding to the signal produced by the amplifier and filter circuit; and
wherein the computing system comprises
a microprocessor;
memory;
an audio output port; and
an application stored in the memory, the application being configured to send a signal to the audio output port in response to user input, wherein the signal corresponds to a command to be sent to a remotely controlled electronic device.
